(19) United States
(12) Patent Application Publication
(10) Pub. No.: US 2004/0130578 A1
(43) Pub. Date: Jul. 8, 2004

(54) Method and system for selection of menu items in a telephone menu screen interface

(76) Inventor: Douglas Charney, Richmond (CA)

Correspondence Address: MICHAEL D. BEDNAREK, SHAW PITTMAN LLP, 1650 TYSONS BOULEVARD, MCLEAN, VA, 22102, US

(21) Appl. No.: 10/400,649

(22) Filed: Mar. 28, 2003

Related U.S. Application Data
(60) Provisional application No. 60/438,534, filed on Jan. 8, 2003.

(51) Int. Cl. G09G 5/00

(52) U.S. Cl. 345/810

(57) ABSTRACT

Systems and methods are described for configuring a menu screen interface in which a user can navigate between menu items by depressing telephone buttons a minimum number of times. In this manner, a user can quickly and easily navigate a menu screen that provides available features and services on a telephone. In a disclosed embodiment, a hierarchical menu screen interface is provided in which navigation and selection between tiers of the menu screen is accomplished by a singular movement of a joystick on the telephone. Alternatively, the user depresses a single button on the telephone to identify and select a desired menu item. Icons on the menu screen are arranged to allow for combined functionality from single telephone buttons.

### BACKGROUND

1. Field of the Invention

The present invention relates generally to menu screen user interfaces and interactive display arrangements for electronic devices, and more particularly to methods for navigating a telephone menu screen interface.

2. Background of the Invention

During the past decade, in part due to improved storage capacity and reduced power requirements for semiconductor memories and improved resolution in liquid crystal displays, there have been significant advancements in capabilities and features provided in portable consumer electronic devices. Such developments in the telephone industry have been particularly dramatic, especially for mobile cellular and cordless telephones. In addition to the standard functionality for placing telephone calls, modem telephones now include calling logs and telephone directories, and allow users to adjust ring volume and tone, among many other features. With the advent of these new features, however, the operation of telephones has become increasingly complex.

To reduce the complexity associated with the new features that are available for modem telephones, many telephones include user interfaces in which applications or telephone functions are selectable through a display screen. Instead of having a confusing array of dedicated buttons for each possible feature, such telephones have universal “menu” keys that toggle the telephone display screen between a telephone calling mode and other feature modes. For many modem telephones, the “menu mode” then displays lists of features to be selected, with a variety of options within each feature.

FIG. 1 provides an example of a typical menu listing that is available for a modern digital cellular telephone, illustrated in FIG. 2. As can be seen in FIG. 1, the first tier identifies selections such as “call log,” “settings,” “profiles,” and “messages”. A selection can then be made by depressing an “up” 10 or “down” 20 button on the cellular telephone of FIG. 2 a series of times until the desired feature is highlighted in the display, and then depressing another “selection” key 30 to confirm the choice. Upon indicating a selection, such as “settings,” the second tier of menu items for that category is then presented. This procedure continues, as shown in the third tier, until a final selection is made (e.g., “Anykey Answer”), or the user presses the “Exit” button 40 and leaves the “menu” mode.

Although the menu listing as described with reference to FIG. 1 enables a user to access a variety of features without having to utilize many different sets of keys for each feature, it instead requires users to depress the same keys repeatedly to highlight the desired feature. In the example provided above, the user would have to depress the “up” button 15 times and a “selection” button 3 times in order to complete the selection. This can be quite frustrating, particularly if the user is in a hurry or is otherwise unable to stare at the telephone display for a long period of time (e.g., while driving, while cooking, etc.). Moreover, if the user attempts to quickly select the feature by depressing the “up” or “down” buttons in a rapid manner, it becomes easy for the user to select the wrong feature accidentally, thereby compounding the user's sense of frustration.

As an alternative to the text-based listing of features on a telephone display, it has become known to incorporate a two-dimensional menu display for selecting features. Using “left” and “right” buttons in conjunction with “up” and “down” buttons, a user is enabled to move a cursor across a multitude of choices on a first screen, select a menu item, and then continue through a hierarchy of other screens within the menu. A two-dimensional menu can provide more information on a single screen than in a one-dimensional listing. Further, a two-dimensional menu often enables a user to navigate through selections with less cursor movement.

FIG. 3 provides an example of a conventional two-dimensional listing arrangement of menu items that were provided in the first tier of FIG. 1. The figure also includes bi-directional arrows between the menu items (in horizontal and vertical directions) to illustrate possible cursor movement. As can be seen, if the “messages” menu item is highlighted, a user can select any of three other menu items (“settings,” “profiles,” or “calendar”) by operation of a single cursor movement (one button) and a selector key (one button), as opposed to only being able to select any of two menu items in a one-dimensional list. Therefore, continuing with this example, the user can move the cursor from “settings” to “messages” via a single horizontal movement, as opposed to having to depress the “down” button two times, as would be required in the one-dimensional menu in FIG. 1.

Although the two-dimensional menu screen provided in FIG. 3 facilitates easy navigation between menu items resulting from “side-to-side” movement in conjunction with the “up-down” movement, this configuration still requires users to depress buttons an excessive number of times. For example, if the “calculator” item is highlighted, selection of the “settings” item would still require a user to depress each of the following buttons: down button (one time), left button (three times), and selection button (one time).

Accordingly, there is a need for a method and system for configuring a menu screen structure to further minimize the number of telephone buttons to be depressed to navigate the menu.

### SUMMARY OF THE INVENTION

Systems and methods are described for configuring a menu screen interface in which a user can navigate between menu items by depressing telephone buttons a minimum number of times. In this manner, a user can quickly and easily navigate a menu screen that provides available features and services on a telephone. In a disclosed embodiment, a hierarchical menu screen interface is provided in which navigation and selection between tiers of the menu screen is accomplished by a singular movement of a joystick on the telephone. Alternatively, the user depresses a single button on the telephone to identify and select a desired menu item. Icons on the menu screen are arranged to allow for combined functionality from single telephone buttons.

In accordance with an embodiment of the present invention, a menu system for a telephone display on a telephone is described. The system includes a plurality of menu items to be displayed on a menu screen, each associated with an application to be provided by the telephone in response to a selection by a user. The system additionally includes a navigational indicator for providing signals to indicate a selection of one of the plurality of menu items. Each of the plurality of menu items is associated with a different signal from the navigational indicator.

In accordance with another embodiment of the present invention, a hierarchical menu system for a telephone display on a telephone is described. The system includes a plurality of menu screens in a plurality of tiers of a hierarchical menu, each associated with a plurality of unique menu items capable of selection by a user. Additionally, a navigational indicator is included for providing signals to indicate a selection of one menu item on a menu screen. Each menu item in a menu screen is associated with a different signal from the navigational indicator, and selection of a menu item in a menu screen triggers display of a corresponding sub menu screen in a sub tier of the hierarchical menu.

A menu system for a telephone display on a telephone is also described as comprising a set of switches, a menu database, and a display. The set of switches provides input signals to a CPU to indicate a selection of one of a plurality of menu items. The menu database stores identification of menu screens in a plurality of tiers of a hierarchical menu, where each menu screen is associated with a plurality of unique menu items capable of selection by a user. The display is for displaying menu screen containing menu items. Each menu item in a menu screen is associated with a different switched input signal. Selection of a menu item in a menu screen in a tier of the hierarchical menu triggers display of a corresponding sub menu screen in a sub tier of the hierarchical menu.

A method for selecting menu items from a menu screen is also described. A plurality of menu items are displayed on a menu screen, each associated with an application to be provided by the telephone in response to a selection by a user. An input signal is received to indicate a selection of one of the plurality of menu items, wherein each of the plurality of menu items is associated with a different input signal, and the input signal is generated by singular movement of a navigational indicator.

### BRIEF DESCRIPTION OF THE DRAWINGS

FIG. 1 is an illustration of a known one-dimensional menu listing in a cellular telephone.

FIG. 2 is an illustration of a known faceplate and screen for a cellular telephone providing the one-dimensional menu listing of FIG. 1.

FIG. 3 is an illustration of a known two-dimensional menu of menu items from FIG. 1.

FIG. 4A is a telephone having a joystick interface in accordance with an embodiment of the present invention.

FIGS. 4B-4D illustrate directional movement of the joystick interface for the telephone in FIG. 4A.

FIG. 5A is a telephone having a set of directional buttons in accordance with another embodiment of the present invention.

FIGS. 5B-5C illustrate directional movement of the directional buttons for the telephone in FIG. 5A.

FIG. 6 is a schematic diagram of components in the telephone of FIG. 4A or FIG. 5A in accordance with an embodiment of the present invention.

FIG. 7 is an illustration of a hierarchical menu structure in accordance with an embodiment of the present invention.

FIG. 8 is an illustration of a plurality of menu screens in the hierarchical menu structure of FIG. 7.

FIG. 9 is an illustration of a plurality of menu screens in a hierarchical menu structure in accordance with an alternative embodiment of the present invention.

FIG. 10 is an illustration of exemplary portion of a hierarchical menu structure for a telephone in accordance with a preferred embodiment of the present invention.

### DETAILED DESCRIPTION OF THE PREFERRED EMBODIMENTS

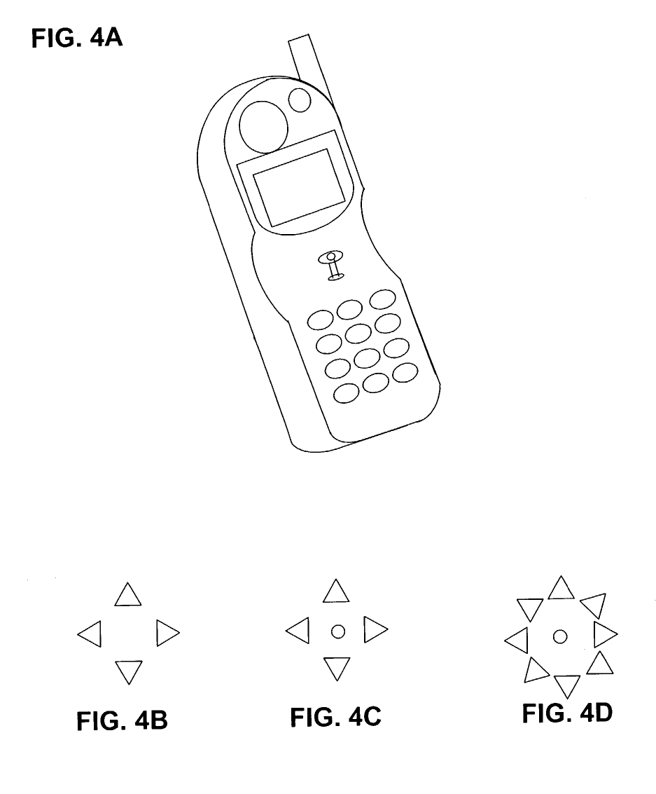

FIG. 4A is an illustration of a telephone that enables a user to navigate a hierarchical menu screen interface in accordance with an embodiment of the present invention. As can be seen, the telephone, which can be a cordless or wired telephone operating in a landline network or a mobile telephone operating a wireless network (e.g., cellular, digital cellular, PCS, satellite, etc.), includes a joystick 40 that protrudes slightly from the faceplate of the unit. Depending upon the implementation, as will be described below in further detail, the joystick may be operable, for example, in four directions as shown in FIG. 4B (up, down, left, right), in five directions as shown in FIG. 4C (up, down, left, right, and center), or in nine directions as shown in FIG. 4D (up, down, left, right, diagonal, and center).

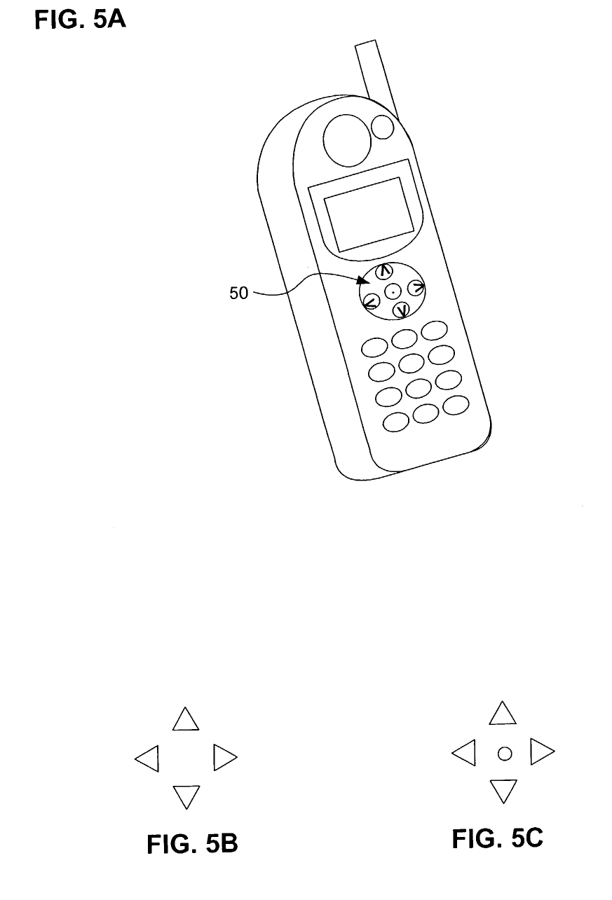

FIG. 5A is an illustration of another telephone for navigating a hierarchical menu screen interface in accordance with an alternative embodiment. Instead of a joystick, this telephone includes a set of directional buttons 50. Once again, depending upon the implementation, there may be, for example, four buttons as shown in FIG. 5B (up, down, left, right), or five buttons as shown in FIG. 5C (up, down, left, right, center).

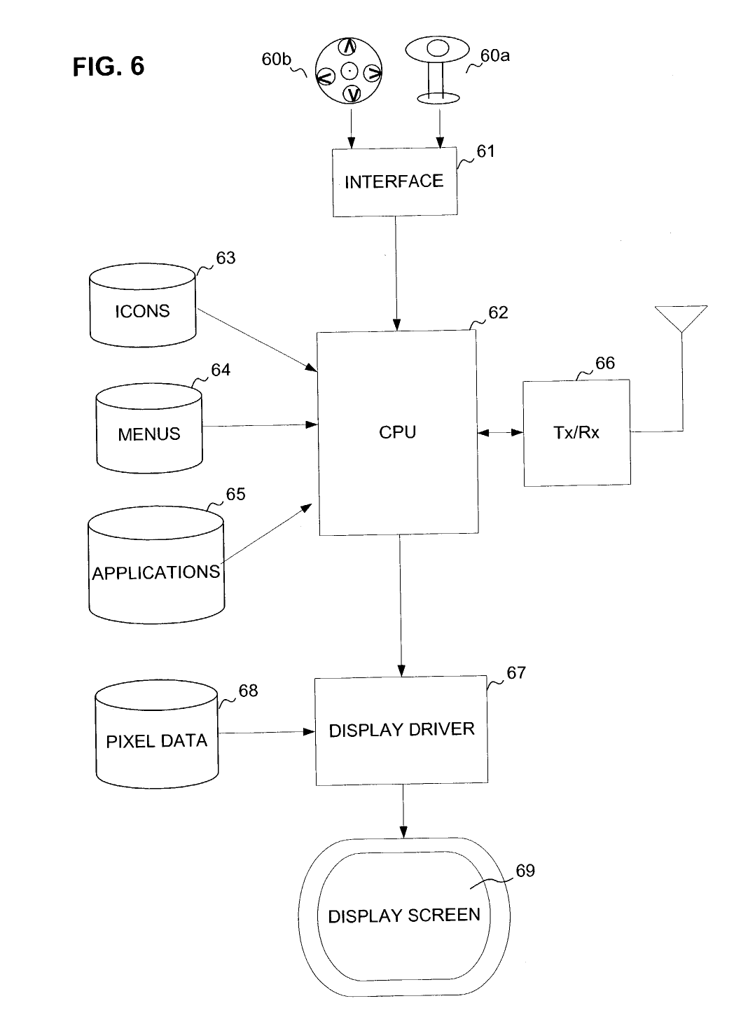

FIG. 6 is a schematic diagram of components in the telephones of FIGS. 4A or 5A. Joystick 60a or directional buttons 60b are each comprised of a set of switches that are a part of an interface 61 that is input to CPU 62. In other words, depending upon the configuration, each possible movement of the joystick (e.g., up, down, left, right, diagonal, inward) can be a switched response via interface 61 that feeds a unique input signal to CPU 62. Of course, the telephone can be configured such that diagonal movements are not recognized. In the same manner, each direction button 60b also provides a unique input signal to CPU 62, just as any other telephone button on a telephone.

The CPU 62 is also connected to memory to retrieve information to display to the user in response to triggering a switch 60a, 60b as detected within interface 61. This may include an icons database 63 storing icons for representing menu items or applications. For example, a pictorial representation of a telephone book may appear on the display to represent a telephone directory. A menu database 64 stores menu layouts to identify menu items and their placement on a respective tier of a hierarchical menu. For example, the top tier of the menu might include icons for “settings,” “voicemail,” “redial,” and “call log.” Applications database 65 stores the underlying application selected (e.g., voicemail data).

The CPU is also connected to a display driver 67, which generates the telephone display 69 based upon information stored in memory 63-65 or otherwise provided by the CPU 62 (a complete bus architecture is not shown in this illustration). The pixel arrangement in the display is also determined in part based upon pixel data 68.

The CPU additionally may be connected to a transmitter/receiver, which may communicate with a base unit (in the example of a cordless, landline telephone) or a mobile switching center (in the example of telephone in the wireless network). The transmitter/receiver supports data transmission for voicemail and other features and applications that may be selected utilizing the menu.

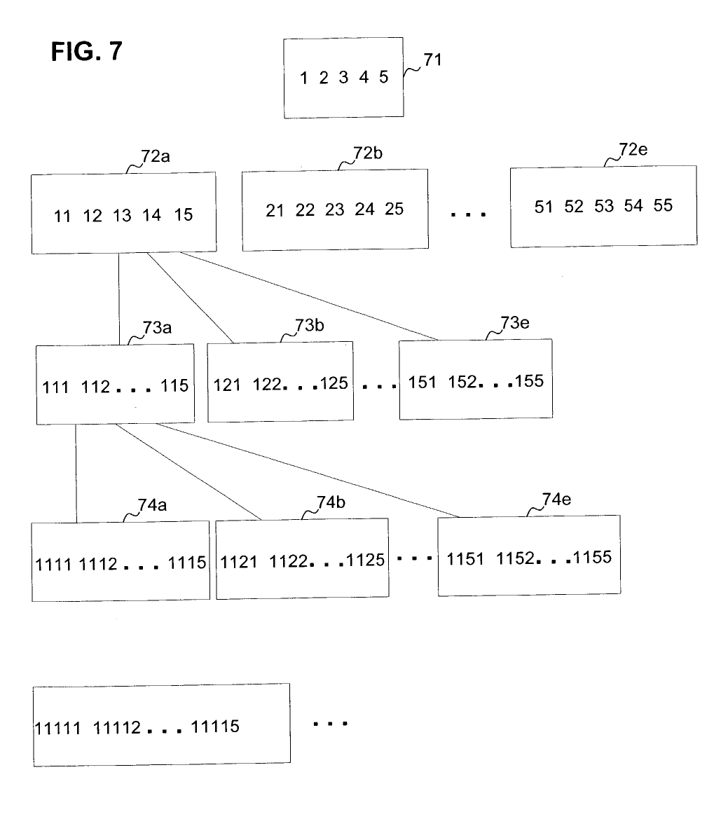

FIG. 7 is an illustration of an exemplary hierarchical menu interface according to an embodiment of the present invention. As can be seen, the menu is comprised of a plurality of successive tiers, or levels of intermediate choices for choosing a particular program, application or feature associated with the telephone. Upon being presented five choices in the initial menu 71, a user can then choose to navigate one of five sub-menus 72a, 72b . . . 72e. From there, the user then can choose one of another five sub-menus 73a, 73b . . . 73e, then another five 74a, 74b . . . 74e, etc. After the first menu tier, the total number of available choices increases exponentially (i.e., 5, 25, 125, etc.).

The menu hierarchy in FIG. 7 illustrates a hierarchical arrangement of submenus, in which each submenu has five choices. However, the present invention is not intended to be limited to any particular number of choices, or even a system in which each submenu or each tier has the same number choices. To the contrary, it is entirely possible, for example, that a submenu for one feature, such as “voicemail,” may encompass several subtiers, each with many choices (e.g., “create outgoing message,” “store message,” “delete message,” “play message,” etc.), whereas another feature, such as “redial,” may encompass only a single tier and a single choice. As will now be described, an advantage of an embodiment of the present invention is that a user can navigate to each successive tier of the menu of FIG. 7 with only a single joystick movement, or by depressing a single button (in the alternative embodiment).

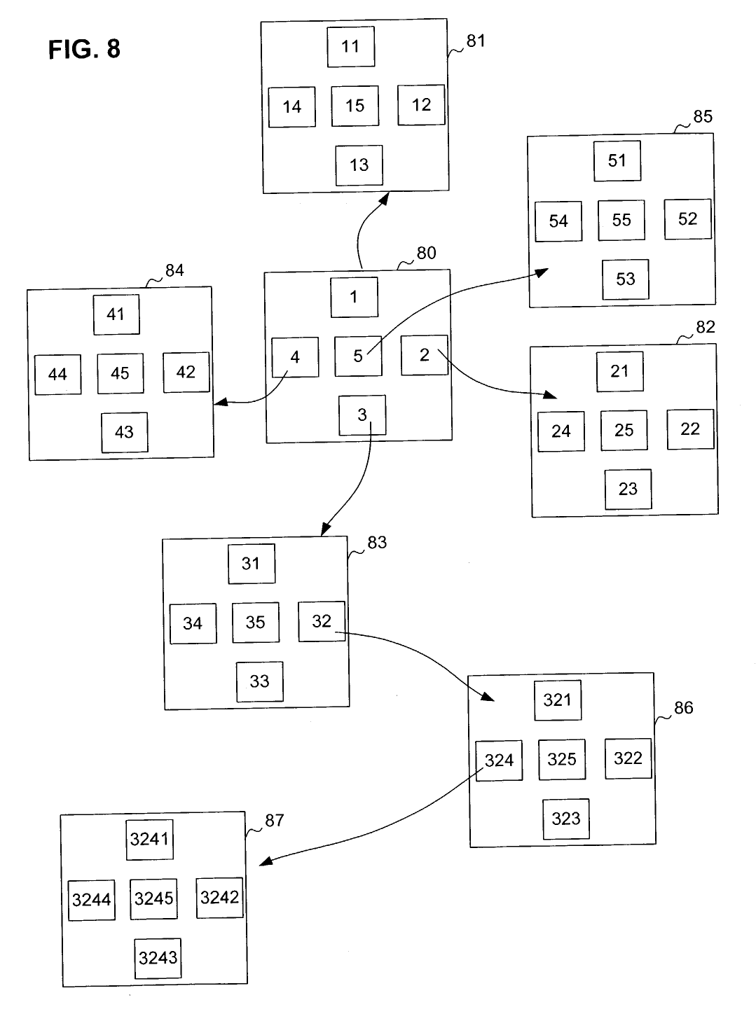

FIG. 8 exemplifies navigation between successive tiers of a menu in accordance with an embodiment of the present invention. More particularly, navigation between four tiers of a menu is shown. In this example, the top-tier menu 80 includes five choices of features, programs, or applications from which a user can select, respectively numbered “1,” “2,” “3,” “4,” and “5.” By selecting one of these choices, the telephone then displays another respective menu screen 81, 82, 83, 84, 85. It is to be understood that each numbered menu item corresponds to a different feature, or a different option associated with a feature.

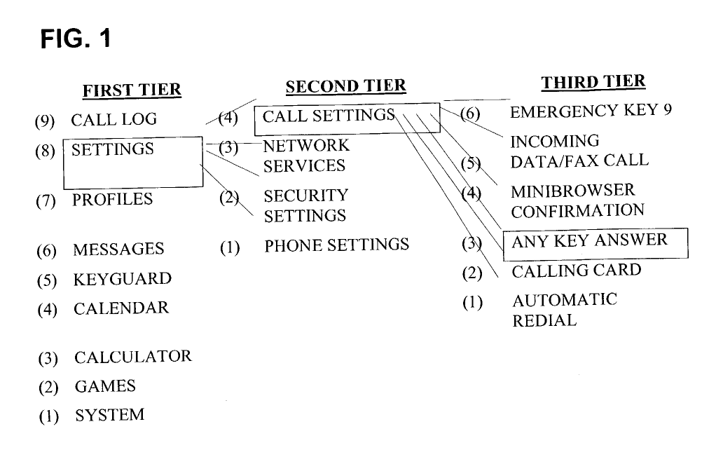

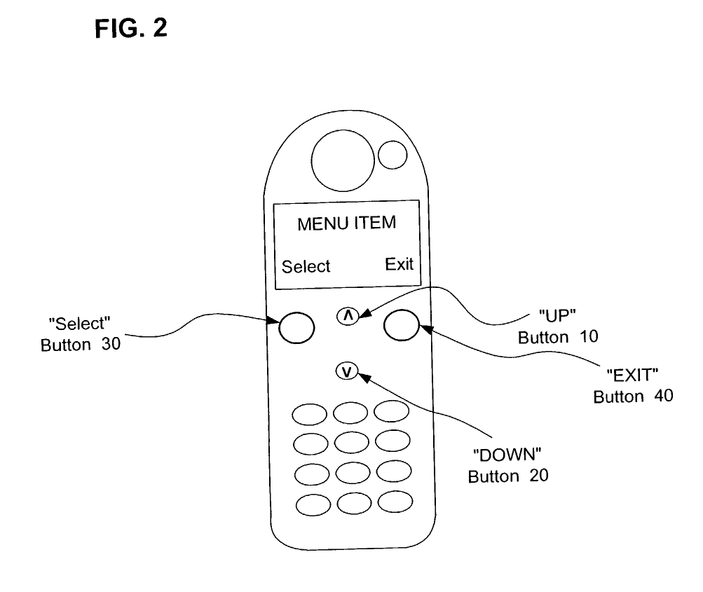

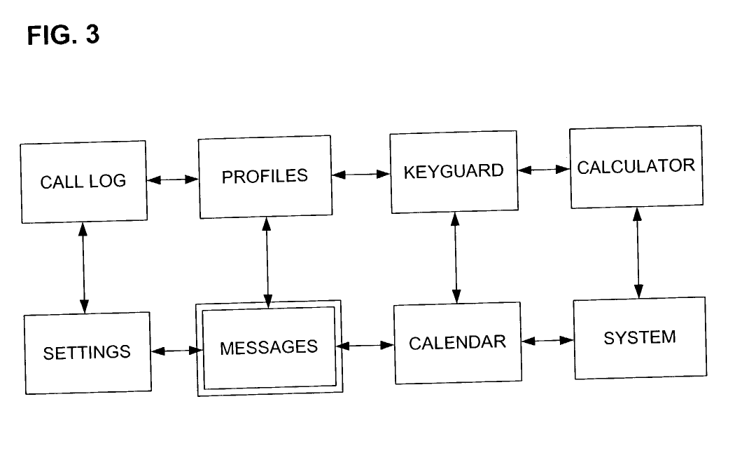

In accordance with an embodiment of the present invention, any of the five menu items in menu 80 is selected by a single movement of the joystick of FIGS. 4A and 4C, or by depressing a single button as shown in FIGS. 5A and 5C. In known menu systems on displays of telephones, such as those shown in FIGS. 1 and 3, a menu item is always highlighted. For example, in FIG. 3, the menu item “messages” is highlighted. If the user wishes to select that menu item, the user depresses a “select” button. However, if the user wishes to select the “calculator” menu item, then the “right” button must be depressed twice, followed by the “up” button to move the highlighted cursor to “calculator,” and then depress the “select” button.

In contrast, there is no highlighted menu item in menu display 80. Instead, for example, menu item “1” is selected simply by moving joystick 40 upward a single time. Movement of the joystick is detected in interface 61 to cause CPU 62 to retrieve a new menu display from menus database 64, with different icons from icons database 63. Accordingly, the menu items are selected by the following movements:

“1” is selected up a single upward movement of the joystick

“2” is selected by a single movement to the right

“3” is selected by a single downward movement

“4” is selected by a single movement to the left

“5” is selected by a single movement of the joystick inward

There is no “select” button to be pressed, since its functionality is rendered unnecessary.

Continuing with FIG. 8, upon selection of a menu item, a sub-menu is generated and displayed providing additional features or activities associated with the selected menu item. As one example, selection of menu item “1” yields submenu 81, containing menu items “11,” “12,” “13,” “14,” and “15.” Item “1” might actually be an icon for “voicemail,” and the menu items on the sub-menu might be “setup voice mailbox,” “create outgoing message,” “listen to messages,” “delete messages,” and “create memo,” respectively. Thus, each menu item in the submenu pertains to a different aspect of the “voicemail” feature. As a second example, selection of menu item “4” yields submenu 84, containing menu items “41,” “42,” “43,” “44,” and “45.”

As shown in FIG. 8, menu item “3” has three different tiers of sub-menus associated with the selection. Selection of “3” yields sub menu 83, containing sub menu items “31,” 32,” “33,” “34,” and “35.” Selection of sub menu item “32” then yields sub-sub menu 86, containing “321,” “322,” “323,” “324,” “325.” Finally, selection of “324” yields sub-sub-sub menu 87, containing “3241,” “3242,” “3243,” “3244,” and “3245.”

In accordance with an embodiment of the present invention, a user can select menu item “3” in menu 80 and navigate from menu 80 to sub-sub-sub menu 87 with three moves of joystick 40: “down” (for “3”), then “right” (for “32”), and then “left” (for “324”). In doing so, the user can select between 15 possible choices with only three movements.

Although the navigation of menus in FIG. 8 has been described with reference to movements of a joystick, it is to be understood that navigation can be performed by depressing a single directional button, using a telephone such as in FIG. 5 having directional buttons 50. As another alternative, instead of “up,” “down,” “left” and “right” directional buttons, navigation can be performed by any other buttons on the telephone. For example, once the telephone is set in “menu” mode, each of the numbered buttons (typically “1”-“9”, “*”, “0”, and “#”) might correspond to a different menu item. If there are only a few menu choices, a subset of these buttons (e.g., just “1”-“9”) might be used.

Returning to the description of FIG. 6, it is recalled that each movement of the joystick is associated with a switched signal, such that each movement provides a unique input signal to the CPU. In FIG. 8, it is appreciated that selection of a menu item in menu 80 by moving a joystick “up,” “down,” “left,” “right,” or “inward” each provides a different input signal to the CPU in the telephone. Once the selection is made, one of the same five respective input signals will be reused for navigation through each submenu. The CPU keeps track of which submenu is being displayed.

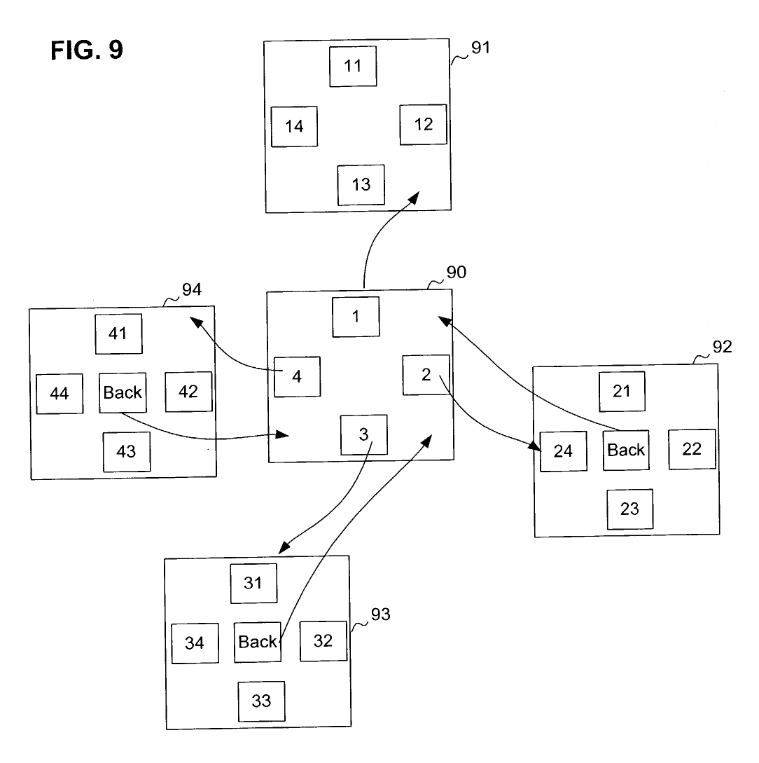

FIG. 9 is another example of an embodiment of the invention, in which there are only four possible selections, “1,” “2,” “3,” and “4,” in the top-tier menu 90, and selection of any one of these menu items generates a respective sub menu 91, 92, 93, or 94. As shown in this Figure, there are five possible selections in the submenus, and for sub menus 92, 93, and 94, the fifth selection is a “go back” key. The “go back” key takes the user back to top tier menu 90, in case the user mistakenly navigated to the wrong sub menu, or otherwise opted not to select a menu item in the submenu. Of course, it is not necessary to provide a “go back” key for each sub menu, as is shown with reference to sub menu 91. Likewise, the menu display can additionally or alternatively provide a “menu exit” button.

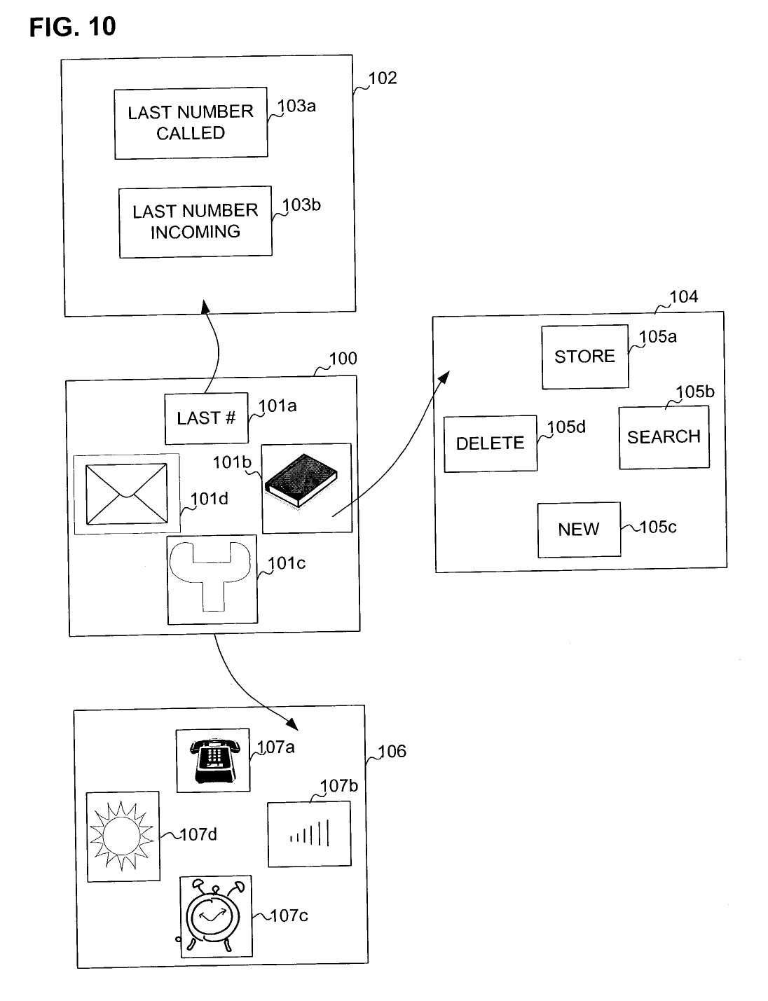

FIG. 10 is an example of an iconic, hierarchical menu with features that may be incorporated into the functionality of a modern telephone. In this example, menu 100 is the top-tier menu display, providing four possible choices. One of the choices is “last #” or “last telephone number,” and the remaining three are identified by icons representing a telephone directory, utilities, and voice mail. Selecting “last #” automatically generates submenu 102, in which choices are presented only for “last number called” 103a and “last number incoming” 103b. Thus, a user can choose between four menu categories and then further choose between receiving the last outgoing and incoming number with a total of only two joystick movements.

If the user chooses to access the telephone directory 101b, then submenu 104 is generated, providing choices to store a dialed number 105a, search for a stored number 105b, add a new number 105c, or delete a number from the directory 105d. Finally, if the user chooses the “utilities” icon 101c to access the utilities sub menu 106, then the user can choose between features such as telephone ringer tone 107a, ringer volume 107b, time setting 107c, and display brightness 107d. Once again, selection of any of these may introduce yet another sub menu (e.g., selection of “time” 107c may provide a sub menu to choose between 12 hour time and 24 hour time).

Using two-dimensional menu arrangements such as those shown and without a movable “highlighted cursor” in the display enables the user to select a menu item or a category with a minimal number of joystick movements or buttons, and without having to additionally depress a “select” button during each stage of menu navigation. A conceivable tradeoff of the improved navigational efficiency concerns the possibility that a user may erroneously select a menu item. This difficulty can be significantly reduced, however, by incorporating a visual or audio confirmation of the user's selection. For example, returning to FIG. 10, if a user moves the joystick upward while in menu 100, the “last #” selection may then blink on the display screen, or appear highlighted, or increase in size and “morph” into menu 102. In this manner, the user can easily confirm a selection with only a quick glance.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A menu system for a telephone display on a telephone, comprising:
a plurality of menu items to be displayed on a menu screen, each associated with an application to be provided by the telephone in response to a selection by a user; and
a navigational indicator for providing signals to indicate a selection of one of the plurality of menu items,
wherein each of the plurality of menu items is associated with a different signal from the navigational indicator.

2. The menu system of claim 1, wherein the navigational indicator is a joystick.

3. The menu system of claim 2, wherein the menu items are each provided on the display at a location corresponding to respective directional joystick movement.

4. The menu system of claim 1, wherein the navigational indicator is a set of telephone buttons.

5. The menu system of claim 4, wherein the set of telephone buttons are directional buttons, and the menu items are each provided on the display at a location corresponding to the direction associated with a respective directional telephone button.

6. The menu system of claim 1, wherein a plurality of the menu items are each associated with a submenu, each submenu comprises a plurality of sub menu items to be displayed on a menu screen, and the navigational indicator provides signals to indicate selection of one of the plurality of submenu items.

7. The menu system of claim 4, wherein selection of one of the sub menu items for at least one submenu returns menu display to a previously displayed menu.

8. A hierarchical menu system for a telephone display on a telephone, comprising:
a plurality of menu screens in a plurality of tiers of a hierarchical menu, each associated with a plurality of unique menu items capable of selection by a user; and
a navigational indicator for providing signals to indicate a selection of one menu item on a menu screen,
wherein each menu item in a menu screen is associated with a different signal from the navigational indicator, and
selection of a menu item in a menu screen triggers display of a corresponding sub menu screen in a sub tier of the hierarchical menu.

9. The hierarchical menu system of claim 8, wherein the navigational indicator is a joystick.

10. The hierarchical menu system of claim 9, wherein the menu items are each provided on the display at a location corresponding to respective directional joystick movement.

11. The menu system of claim 8, wherein the navigational indicator is a set of telephone buttons.

12. The menu system of claim 11, wherein the menu items are each provided on the display at a location corresponding to a corresponding telephone button.

13. A menu system for a telephone display on a telephone, comprising:
a set of switches for providing input signals to a CPU to indicate a selection of one of a plurality of menu items;
a menu database for storing identification of menu screens in a plurality of tiers of a hierarchical menu, each menu screen associated with a plurality of unique menu items capable of selection by a user; and
a display for displaying menu screen containing menu items,
wherein each menu item in a menu screen is associated with a different switched input signal, and
selection of a menu item in a menu screen in a tier of the hierarchical menu triggers display of a corresponding sub menu screen in a sub tier of the hierarchical menu.

14. The hierarchical menu system of claim 13, wherein the set of switches are operated by means of a joystick.

15. The hierarchical menu system of claim 14, wherein the menu items are each provided on the display at a location corresponding to respective directional joystick movement.

16. The menu system of claim 13, wherein the set of switches are operated by means of telephone buttons.

17. The menu system of claim 16, wherein the telephone buttons are directional buttons, and menu items are each provided on the display at a location corresponding to the direction associated with a respective directional telephone button.

18. A method for selecting menu items from a menu screen, comprising:
displaying a plurality of menu items to be displayed on a menu screen, each associated with an application to be provided by the telephone in response to a selection by a user; and
receiving an input signal to indicate a selection of one of the plurality of menu items,
wherein each of the plurality of menu items is associated with a different input signal, and the input signal is generated by singular movement of a navigational indicator.

19. The method of claim 18, wherein the navigational indicator is a joystick.

20. The method of claim 18, wherein the navigational indicator is a set of telephone buttons.
